(19) United States
(12) Patent Application Publication
(10) Pub. No.: US 2025/0072689 A1
(43) Pub. Date: Mar. 6, 2025

(54) CLEANING SYSTEM AND METHOD FOR VEHICLE INTERIOR

(71) Applicants: Hyundai Motor Company, Seoul (KR); Kia Corporation, Seoul (KR)

(72) Inventors: Liang NIE, Yantai (CN); Xia HE, Yantai (CN); Zhe LI, Yantai (CN); Jeonghyeon KIM, Hwaseong-Si (KR); Yan Xiang HUANG, Yantai (CN)

(73) Assignees: Hyundai Motor Company, Seoul (KR); Kia Corporation, Seoul (KR)

(21) Appl. No.: 18/816,853

(22) Filed: Aug. 27, 2024

(30) Foreign Application Priority Data
Aug. 29, 2023 (CN) 202311105504.5

(51) Int. Cl. A47L 11/40; B60R 7/04; B60S 1/64; E05F 15/60; E05F 15/71

(52) U.S. Cl. CPC A47L 11/4011; A47L 11/4083; A47L 11/4091; B60S 1/64; E05F 15/71; A47L 2201/022; A47L 2201/04; B60R 7/04; E05F 15/60; E05Y 2900/538

(57) ABSTRACT

In a cleaning system and method for a vehicle interior, the system includes a floor cleaning device, at least one sensor, a seat lifting device, and a controller. The floor cleaning device is configured to be pulled out from the storage space to clean the floor of a vehicle, at least one sensor detects a driving state of the vehicle and output corresponding state information, the seat lifting device raises and lowers at least a front seat of the vehicle, and the controller determines whether the vehicle is in a parked state according to the state information, controls, if the vehicle is in a parked state, the seat lifting device to raise the at least a front seat of the vehicle and simultaneously controls the floor cleaning device to be drawn out from the storage space to clean the floor of the vehicle.

### CROSS-REFERENCE TO RELATED APPLICATION

The present application claims priority to and the benefit of Chinese Patent Application No. 202311105504.5 filed in the Chinese Intellectual Property Office on Aug. 29, 2023, the entire contents of which is incorporated herein for all purposes by this reference.

### BACKGROUND OF THE PRESENT DISCLOSURE

### Field of the Present Disclosure

The present disclosure relates to the field of vehicle technology, and to a cleaning system and method for a vehicle interior.

### Description of Related Art

As the level of science and technology increases day by day, vehicles have increasingly appeared in people's lives as a means of transportation that people may choose. People's demand for vehicles also began to shift from initially carrying people and traveling long distances to more additional performances.

For example, it is very common to have contaminants (e.g., dust, food particles, etc.) on the floor of a vehicle. Contamination in the environment inside a vehicle may have a negative impact on the health or emotions of occupants. Conventionally, vehicles are not provided with cleaning systems, and in most cases, cleaning is done manually. To meet more automation scenarios, demand for automation of vehicle cleaning has also increased day by day.

The above Description of Related Art merely provides convenience for a deeper understanding of a technical solution (technical units in use, technical problems to be solved, technical effects generated, etc.) of the present disclosure, and the corresponding information should not be regarded as acknowledging configuration of the related art or implying any form known to a person skilled in the art.

### BRIEF SUMMARY

Various aspects of the present disclosure are directed to providing a cleaning system and method for a vehicle interior, configured for implementing automated cleaning of a floor of the vehicle.

According to an exemplary embodiment of the present disclosure, a cleaning system for a vehicle interior includes: a storage space provided on a lower side of a rear seat of a vehicle; a floor cleaning device internally disposed within the storage space and configured to move from the storage space to clean a floor of the vehicle; at least one sensor configured to detect a driving state of the vehicle and to output corresponding state information of the vehicle; a seat lifting device configured to raise and lower at least a front seat of the vehicle; and a controller configured to determine whether the vehicle is in a parked state according to the state information output from at least one sensor, to control, if the vehicle is determined to be in a parked state, the seat lifting device to raise the at least a front seat of the vehicle and simultaneously control the floor cleaning device to move out from the storage space to clean the floor of the vehicle.

The at least one sensor may include an engine state sensor configured for detecting an engine state and a door lock state sensor configured for detecting a door lock state, and the controller is configured to determine whether the vehicle is in a parked state based on engine state information output from the engine state sensor and door lock state information output from the door lock state sensor.

The storage space may include an opening, an electric door is coupled in the opening, and the controller may be configured to control the electric door to be open before the controller controls the floor cleaning device to move out from the storage space, to control the electric door to be closed after the floor cleaning device returns to the storage space, and to control the seat lifting device to lower the front seat of the vehicle to a position of the front seat before the front seat was raised.

The floor cleaning device may be a cleaning robot, and a charging stand and/or a washing tank for the cleaning robot may be provided in the storage space.

The cleaning system may further include: an input device configured to obtain a user input, wherein the controller is configured to control the electric door, the floor cleaning device, and the seat lifting device based on the user input received from the input device.

The input device may be configured to obtain the user input to turn on or off the cleaning function, and the controller may be configured to control the electric door, the floor cleaning device, and the seat lifting device to operate when the vehicle is determined to be in a parked state, based on the user input for turning on the cleaning function received from the input device, and not to control the electric door, the floor cleaning device, and the seat lifting device based on the user input for turning off the cleaning function received from the input device.

The controller may be a vehicle head unit, the input device may be a touch screen provided integrally with a display in the vehicle head unit and may be further configured to obtain a user input regarding a cleaning start time, and the controller may be configured to control the electric door, the floor cleaning device, and the seat lifting device to operate after the cleaning start time has elapsed since the vehicle was determined to be in a parked state, based on the user input of the cleaning start time received from the input device.

The cleaning system may further include: an air purifying device configured to supply air from an outside of the vehicle to the vehicle interior to purify air inside the vehicle, wherein the input device is a touch screen provided integrally with the display of the remote control terminal and is further configured to further obtain a user input regarding a target in-vehicle temperature and a user input regarding a cleaning duration, and the controller is configured to control the electric door, the floor cleaning device, and the seat lifting device based on the user input of the target in-vehicle temperature received from the input device, to control the air purifying device to supply air to the vehicle interior so that an in-vehicle temperature reaches the target in-vehicle temperature, and to control the floor cleaning device to clean the floor of the vehicle within the cleaning duration based on the user input of the cleaning duration received from the input device.

The cleaning system may further include: a remote control server configured to enable communication between a remote control terminal and the controller; and a central gateway configured to enable communication between each of the controller, the air purifying device, and the seat lifting device.

According to another exemplary embodiment of the present disclosure, a cleaning method for a vehicle interior includes: detecting a driving state of a vehicle by at least one sensor and outputting corresponding state information of the vehicle; determining, by the controller, whether the vehicle is in a parked state according to the state information output from at least one sensor; and when the controller determines that the vehicle is in a parked state, controlling, by the controller, the seat lifting device to raise the at least a front seat of the vehicle and simultaneously controlling, by the controller, the floor cleaning device to be drawn out from the storage space and clean the floor of the vehicle.

An engine state may be detected by the engine state sensor, a door lock state may be detected by the door lock state sensor, and whether the vehicle is in a parked state may be determined by the controller based on engine state information output from the engine state sensor and the door lock state information output from the door lock state sensor.

The cleaning method may further include: controlling, by the controller, the electric door provided at an opening of the storage space to be opened, before the controller controls the floor cleaning device to be drawn out from the storage space; and controlling, by the controller, the electric door to be closed after the floor cleaning device returns to the storage space, and controlling the seat lifting device to lower the front seat of the vehicle to a position of the front seat before the front seat of the vehicle was raised.

The cleaning method may further include: obtaining a user input by an input device; and controlling, by the controller, the electric door, the floor cleaning device, and the seat lifting device based on a user input received from the input device.

A user input for turning on or off the cleaning function may be obtained by an input device, the controller may be configured for controlling the electric door, the floor cleaning device, and the seat lifting device to operate, when the controller determines that the vehicle is in a parked state, based on the user input for turning on the cleaning function received by the controller from the input device, and the controller may not control the electric door, the floor cleaning device, and the seat lifting device, based on the user input for turning off the cleaning function received by the controller from the input device.

The controller may be a vehicle head unit, the input device may be a touch screen provided integrally with a display in the vehicle head unit, a user input for a cleaning start time may be obtained by the input device, and the controller is configured to control the electric door, the floor cleaning device, and the seat lifting device to operate after the cleaning start time has elapsed since the vehicle was determined to be in a parked state, based on the user input of the cleaning start time received from the input device.

The input device may be a touch screen provided integrally with a display of a remote control terminal, a user input regarding a target in-vehicle temperature and a user input regarding a cleaning duration may be obtained by the input device, the controller may be configured for controlling the electric door, the floor cleaning device, and the seat lifting device based on the user input of the target in-vehicle temperature received from the input device and control an air purifying device to supply air to the vehicle interior so that an in-vehicle temperature reaches a target in-vehicle temperature, and the controller may be configured for controlling the floor cleaning device to clean the floor of the vehicle within the cleaning duration based on the user input of the cleaning duration received from the input device.

Communication between the remote control terminal and the controller may be enabled by a remote control server, and communication between each of the controller, the air purifying device, and the seat lifting device may be enabled by a central gateway.

The present disclosure adopts the above technical solution and has the following beneficial effects: When a user gets off a vehicle, a cleaning robot automatically cleans the floor of the vehicle, providing people with a clean environment in the vehicle and giving the user a good mood and health. The robot cleaning system of the present disclosure is located on the lower side of the rear seat, is well hidden, does not occupy space in the vehicle, and has a simple structure. The cleaning system may be preset through a display of a vehicle head unit or a remote control terminal, and both the vehicle head unit and the remote control terminal provide a user interface (UI) control window. The user may select various operations from the UI control window. The smart control method provides users with excellent convenience and a smart experience.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

Hereinafter, various exemplary embodiments of the present disclosure are described in more detail by combining the drawings. For clarity of description, like elements in different drawings are denoted by like reference numerals. It should be noted that the drawings are illustrative only and are not necessarily drawn to scale.

FIG. 1 is an overall block diagram of a cleaning system for a vehicle interior according to an implementation method of the present disclosure.

FIG. 2 is a structural schematic diagram of a floor cleaning device arranged in a storage space according to an implementation method of the present disclosure.

FIG. 3 is a structural schematic diagram of a floor cleaning device drawn out from a storage space according to an exemplary embodiment of the present disclosure being.

FIG. 4 is a structural schematic diagram of a front seat after being raised according to an exemplary implementation of the present disclosure.

FIG. 5 is a schematic diagram illustrating a vehicle cleaning user interface displayed on a display of a vehicle head unit (HU).

FIG. 6 is a timing diagram of a cleaning process of a cleaning system for a vehicle interior according to an exemplary embodiment of the present disclosure.

FIG. 7 is a block diagram of a cleaning system for a vehicle interior according to an exemplary embodiment of the present disclosure.

FIG. 8 is a schematic diagram illustrating a vehicle cleaning user interface displayed on a smartphone.

FIG. 9 is a timing diagram of a cleaning process of a cleaning system for a vehicle interior according to an exemplary embodiment of the present disclosure.

FIG. 10 is a flowchart of a cleaning method for a vehicle interior according to an exemplary embodiment of the present disclosure.

FIG. 11 is a flowchart of a cleaning method for a vehicle interior according to another exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, an implementation method of the present disclosure is described in detail. The implementation method is implemented on the premise of the technical solution of the present disclosure, and a detailed implementation method and predetermined operation process are disclosed, but the scope of the present disclosure is not limited to the following implementation method.

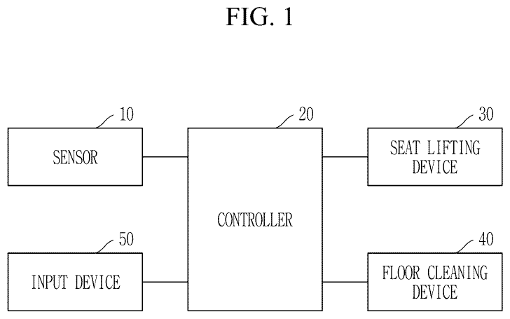

FIG. 1 is an overall block diagram of a cleaning system for a vehicle interior according to an implementation method of the present disclosure. As shown in FIG. 1, the cleaning system for a vehicle interior according to an exemplary embodiment of the present disclosure includes a sensor 10, a controller 20, a seat lifting device 30, a floor cleaning device 40, and an input device 50.

At least one sensor 10 may be provided and configured to detect a driving state of the vehicle and output corresponding state information. The controller 20 is configured to determine whether the vehicle is in a parked state according to the state information output from the at least one sensor 10. For example, the sensor 10 may include an engine state sensor configured for detecting an engine state and a door lock state sensor configured for detecting a door lock state. When the engine state sensor outputs engine OFF state information to the controller 20 and the door lock state sensor outputs door lock-locked state information to the controller 20, the controller 20 may be configured to determine that the vehicle is in a parked state according to a signal output from the engine state sensor and the door lock state sensor.

However, the sensor 10 of the present disclosure is not limited to the engine state sensor and the door lock state sensor, and the sensor 10 may further include a vehicle speed sensor, a gear sensor, a pressure-type seat belt sensor, a seat sensor, etc. Through a combination of these sensors 10, whether the vehicle is in a parked state may be determined. For example, when the vehicle speed sensor detects that a vehicle speed is 0 and the seat sensor 10 detects that no one is seated, the controller 20 may be configured to determine that the vehicle is in a parked state.

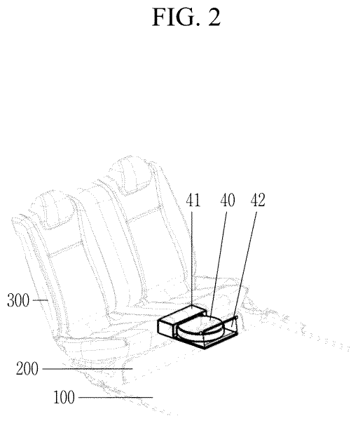

According to the implementation method of the present disclosure, the floor cleaning device 40 is for cleaning the floor of the vehicle. FIG. 2 is a structural schematic diagram of a floor cleaning device 40 arranged in a storage space according to an implementation method of the present disclosure. As shown in FIG. 2, a storage space 200 is provided below a rear seat 300 of the vehicle, and the floor cleaning device 40 is internally disposed within the storage space 200 and drawn out from the storage space 200 to clean the floor 100 of the vehicle. The floor cleaning device 40 may be a cleaning robot. The cleaning robot may automatically move along a path, and during the movement process, the cleaning robot may draw floor impurities into its own waste storage bin, completing a floor cleaning function.

Furthermore, a charging stand 41 for a cleaning robot may be provided in the storage space 200. The charging stand 41 is a charging device for the cleaning robot. When the cleaning robot completes cleaning or an electricity level of the cleaning robot is low, the cleaning robot may automatically return to the storage space 200 and may be charged within the charging stand 41. A cleaning tank may be further provided in the charging stand 41, and thus, cleaning work for two rotating mops at the bottom portion of the cleaning robot may be completed.

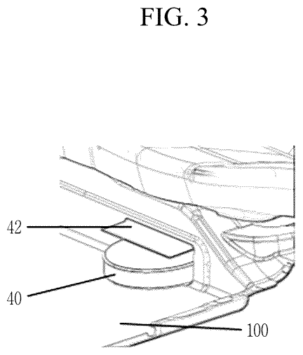

After the vehicle is determined to be in a parked state by the controller 20, the controller 20 may be configured for controlling the floor cleaning device 40 to be drawn out from the storage space 200 to clean the floor 100 of the vehicle. FIG. 3 is a structural schematic diagram of a floor cleaning device 40 drawn out from a storage space 200 according to an exemplary embodiment of the present disclosure. Referring to FIG. 2 and FIG. 3, an opening is formed in the storage space 200, and an electric door 42 is provided in the opening and includes an actuator operably connected to the controller 20. The controller 20 is configured to control the electric door 42 to be opened before the floor cleaning device 40 is drawn out from the storage space 200, and is configured to control the electric door 42 to be closed after the floor cleaning device 40 returns to the storage space 200.

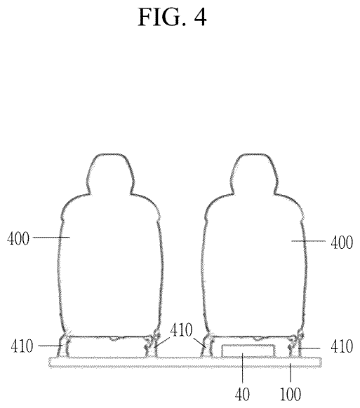

The floor 100 of the vehicle is almost flat, making it suitable for the cleaning robot to perform. However, in the case of the rear seat 300, a height between the seat and the bottom is insufficient, so that the floor cleaning device 40 cannot pass through and the seat may interfere with cleaning by the floor cleaning device 40. Accordingly, a seat lifting device 30 is provided in the cleaning system for a vehicle interior according to the implementation method of the present disclosure and the seat lifting device 30 is used to raise and lower the at least a front seat of the vehicle. For example, in a vehicle with two rows of seats, the seat lifting device 30 is for raising and lowering the front seat of the vehicle, and in a vehicle with three rows of seats, the seat lifting device 30 is for raising and lowering the center seat and the front seat of the vehicle. Hereinafter, a vehicle provided with two rows of seats is taken as an example. FIG. 4 is a structural schematic diagram of a front seat after being raised according to an exemplary implementation of the present disclosure. As shown in FIG. 4, in a specific exemplary embodiment of the present disclosure, the front seat 400 includes a lower base 410, and the base 410 may be elongated under the driving of the seat lifting device 30. After the base 410 is elongated, the floor cleaning device 40 may clean a lower side of the front seat 400 and pass from a lower side of the front seat 400.

The controller 20 is configured to control the seat lifting device 30 to raise the at least a front seat 400 of the vehicle when the vehicle is in a parked state and is configured to control the floor cleaning device 40 to be simultaneously drawn out from the storage space 200 to clean the floor 100 of the vehicle.

The cleaning system for a vehicle interior according to the implementation method of the present disclosure may further include the input device 50. The input device 50 may obtain user input. The input device 50 may receive an input related to various functions and/or operations of vehicle cleaning. The input device 50 may include an ON/OFF button, a selection button, a physical button (e.g., a button for executing various functions), a jog dial, and/or a touch pad. Furthermore, the input device 50 may include a touch screen provided integrally with the display.

The display may display information related to a vehicle cleaning operation. Furthermore, the display may display a user interface (UI) which may interact with the user. The display may include a touch screen and receive a touch input from the user. The display may convert the user's touch input into an electrical signal and send the electrical signal to the controller 20. The controller 20 may be configured for processing the electrical signal according to the user's touch input and control the operation of the electric door 42, the floor cleaning device 40, and the seat lifting device 30 in response to the processing.

The input device 50 may obtain a user input for turning on or off the cleaning function. When the controller 20 determines that the vehicle is in a parked state based on the user input for turning on the cleaning function received from the input device 50, the controller 20 is configured to control the electric door 42, the floor cleaning device 40, and the seat lifting device 30 to operate. The controller 20 does not control the electric door 42, the floor cleaning device 40, and the seat lifting device 30 based on the user input for turning off the cleaning function received from the input device 50.

The controller 20 may perform overall control so that each device may function normally. The controller 20 may be implemented in a form of hardware, may be implemented in a form of software, or may be implemented in a form of a combination thereof. The controller 20 may be formed integrally with an internal control unit of the vehicle or may be implemented as a separate hardware device and may be connected to the control unit of the vehicle through a connection unit. In the exemplary embodiment of the present disclosure, the controller 20 may be implemented through a vehicle head unit (HU).

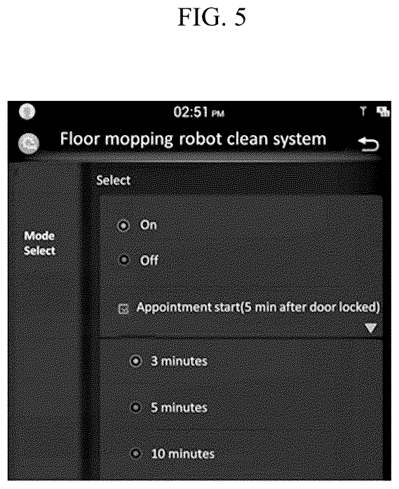

In an implementation, the input device 50 may be a touch screen provided integrally with a display of the HU or may be a display of an audio, video, navigation, and audio video navigation telematics (AVNT) system. The display of the HU may display an application (APP) related to vehicle cleaning, and after the user operates the APP displayed on the touch screen, the display may display a vehicle cleaning user interface. FIG. 5 is a schematic diagram illustrating a vehicle cleaning user interface displayed on the display of the HU. As shown in FIG. 5, the user may select whether to turn on a cleaning function through the user interface. When the user selects “ON” on the user interface, the controller 20 may be configured for controlling the electric door 42, the seat lifting device 30, and the floor cleaning device 40 according to the user's touch input. Conversely, if the user selects “OFF” on the user interface, the controller 20 does not control the electric door 42, the seat lifting device 30, and the floor cleaning device 40 according to the user's touch input.

Furthermore, the input device 50 may be further configured to obtain a user input for a cleaning start time, and the controller 20 may be configured for controlling the electric door 42, the floor cleaning device 40, and the seat lifting device 30 after the cleaning start time has elapsed since the vehicle was determined to be in a parked state, based on the user input of the cleaning start time received from the input device 50. As shown in FIG. 5, the user may select a cleaning time of the floor cleaning device 40 through a user interface. As shown in FIG. 5, the user may select a cleaning start time of the floor cleaning device 40 through a user interface. The user may select one of “3 minutes”, “5 minutes” or “10 minutes” on the user interface. For example, the user selects “3 minutes” on the user interface. After 3 minutes have elapsed since the vehicle was determined to be in a parked state by the controller 20, the controller 20 is configured to control the electric door 42 to be opened, controls the floor cleaning device 40 to be drawn out from the storage space 200 to clean the floor 100 of the vehicle, and controls the seat lifting device 30 to raise the at least a front seat 400 of the vehicle. Therefore, the cleaning system according to an implementation method of the present disclosure may implement reservation for a cleaning time, and the floor cleaning device 40 does not need to start cleaning immediately every time the vehicle is parked.

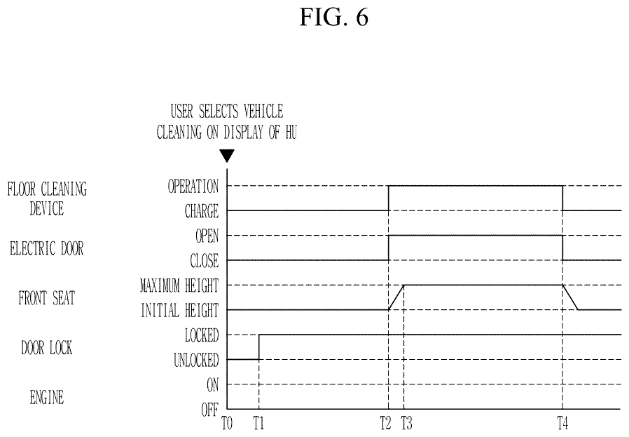

FIG. 6 is a timing diagram of a cleaning process of a cleaning system for a vehicle interior according to an exemplary embodiment of the present disclosure. As shown in FIG. 6, the user selects ON of the vehicle cleaning function through the input device 50 (i.e., the display of HU), and at a TO time, vehicle cleaning is selected as ON. To park, the user may first turn off the engine, get off the vehicle, and lock the door lock using a smart key. At the instant time, the controller 20 (The HU) may be configured to determine that the vehicle is in a parked state at time point T1. The cleaning start time is from time point T1 to time point T2. From time point T2, the HU may be configured for controlling the seat lifting device 30 to raise the front seat 400, and at time point T3, the front seat 400 rises to a maximum height, and the time from time point T2 to time point T3 may be from 5 to 30 seconds. Furthermore, starting at time point T2, the HU is configured to control the electric door 42 to be opened and the floor cleaning device 40 to be drawn out from the storage space 200. from time point T2 to time point T4, the floor cleaning device 40 is in a working state to clean the floor. At time point T4, the floor cleaning device 40 completes cleaning the floor and returns to the storage space 200. After time point T4, the floor cleaning device 40 may be charged or automatically cleaned on the charging stand 41. Furthermore, at time point T4, the HU is configured to control the electric door 42 to be closed, controls the front seat 400 to start lowering, and the front seat 400 is lowered to a position (i.e., an initial position) before it was raised.

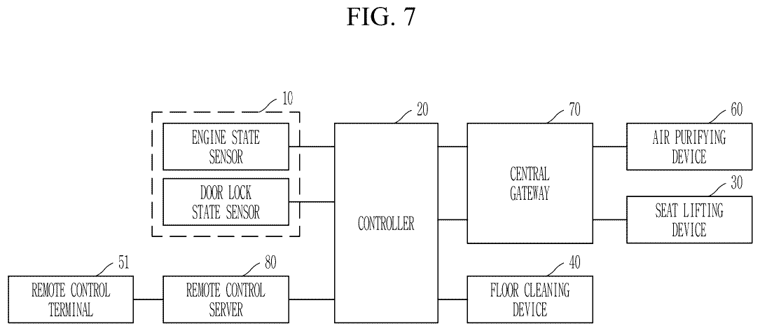

FIG. 7 is a block diagram of a cleaning system for a vehicle interior according to an exemplary embodiment of the present disclosure. In another implementation, the input device 50 may be a touch screen provided integrally with a display of a remote control terminal 51. The remote control terminal 51 may include a smartphone, PC, laptop, etc. As shown in FIG. 7, the cleaning system for a vehicle interior according to an exemplary embodiment of the present disclosure may include a remote control server 80, and the remote control server 80 may be a remote information processing management service (telematics management service (TMS)) center. The remote control server 80 enables communication between the remote control terminal 51 and the controller 20.

Before the user starts a single driving course, the floor may be cleaned by first turning on the floor cleaning device 40 remotely through a smartphone, so that the floor is clean when the user gets in. Since the doors and windows are generally closed when the vehicle is parked, if the vehicle is parked in the sunlight, an in-vehicle temperature may rise and air quality inside the vehicle may become very poor. Thus, the user of the vehicle needs to purify the air inside the vehicle before riding to lower the in-vehicle temperature and discharge harmful gases.

Therefore, according to another exemplary embodiment of the present disclosure, the cleaning system for a vehicle interior further includes an air purifying device 60. The air purifying device 60 is configured to purify the air inside the vehicle by supplying air from an outside of the vehicle to the vehicle interior. For example, the air purifying device 60 may be an air-conditioner. As shown in FIG. 7, the controller 20 (specifically, the HU) is electrically connected to the air purifying device 60 and the seat lifting device 30 through a central gateway (CGW) 70. The central gateway 70 enables communication between each of the controller 20, the air purifying device 60, and the seat lifting device 30.

Similarly, the remote control terminal 51 (specifically, a smartphone) as the input device 50 may receive a user input for turning on or off the cleaning function. When the controller 20 receives a user input to turn on the cleaning function from the remote control server 80, if it is determined that the vehicle is in a parked state, the controller 20 may be configured for controlling the electric door 42, the floor cleaning device 40, the seat lifting device 30, and the air purifying device 60 to operate. When the controller 20 receives a user input for turning off the cleaning function from the remote control server 80, the controller 20 does not control the electric door 42, the floor cleaning device 40, the seat lifting device 30, and the air purifying device 60.

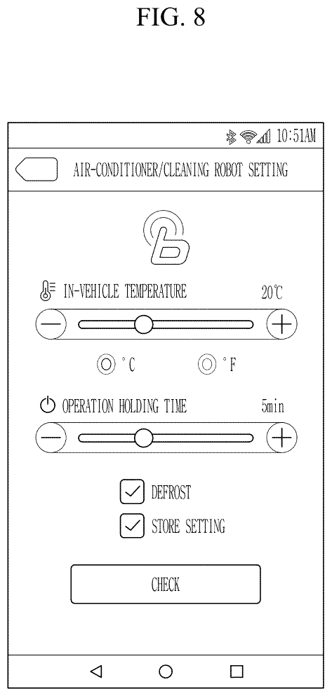

Furthermore, the input device 50 (specifically, the remote control terminal 51) may be further configured to obtain a user input regarding a target in-vehicle temperature and a user input regarding a cleaning duration. Based on the user input of the target in-vehicle temperature received from the input device 50 (specifically, the remote control terminal 51), the controller 20, specifically the HU, may be configured for controlling the electric door 42, the floor cleaning device 40, and the seat lifting device 30 and simultaneously control the air purifying device 60 to supply air to the vehicle interior so that the in-temperature vehicle reaches the target in-vehicle temperature. The controller 20 may be configured for controlling the floor cleaning device 40 to clean the floor of the vehicle within the cleaning duration based on the user input of the cleaning duration received from the input device 50, e.g., the remote control terminal 51. FIG. 8 is a schematic diagram illustrating a vehicle cleaning user interface displayed on a smartphone. As shown in FIG. 8, the user may select an in-vehicle temperature (i.e., a target in-vehicle temperature) and an operation holding time (i.e., cleaning duration) on the user interface by dragging a progress bar.

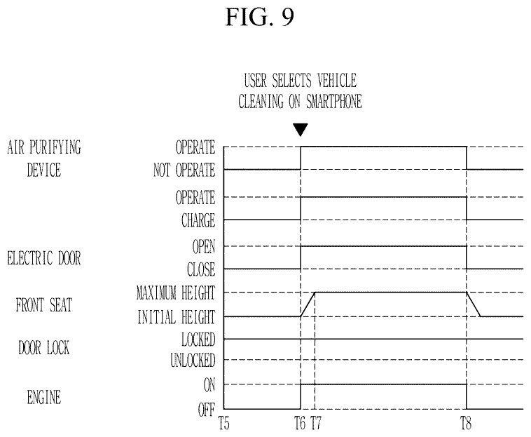

FIG. 9 is a timing diagram of a cleaning process of the cleaning system for a vehicle interior according to an exemplary embodiment of the present disclosure. As shown in FIG. 9, from time point T5 to time point T6, the engine of the vehicle is turned off, the door lock is locked, and the vehicle is in a parked state. At time point T6, the user selects vehicle cleaning ON on the smartphone. Similar to the aforementioned implementation method, starting at time point T6, the HU is configured to control the seat lifting device 30 to raise the front seat 400, and at time point T7, the front seat 400 rises to the maximum height, and the time from time point T6 to time point T7 may be in the range of 5 seconds to 30 seconds. Furthermore, from time point T6, the HU is configured to control the electric door 42 to be opened and the floor cleaning device 40 to be drawn out from the storage space 200. From time point T6 to time point T8, the floor cleaning device 40 is in a working state to clean the floor. The time from time point T6 to time point T8 is the cleaning duration. Another difference is that the cleaning system of the exemplary embodiment of the present disclosure further includes the air purifying device 60, and the air purifying device 60 cleans the air inside the vehicle from time point T6. To provide an energy source to the air purifying device 60, at time point T6, the engine is switched from the OFF state to the ON state. At time point T8, the floor cleaning device 40 completes cleaning the floor and returns to the storage space 200. After time point T8, the floor cleaning device 40 may be charged on the charging stand 41 or automatically cleaned. Furthermore, at time point T8, the HU is configured to control the engine to be turned off, the air purifying device 60 to be turned off, the electric door 42 to be closed, and the front seat 400 to start lowering, and the front seat 400 is lowered to a position (i.e., the initial position) before it was raised.

An exemplary embodiment of the present disclosure further provides a cleaning method for a vehicle interior, and the method includes detecting a driving state of a vehicle by at least one sensor 10 and outputting corresponding state information, determining, by the controller 20, whether the vehicle is in a parked state according to the state information output from at least one sensor, and when the controller 20 determines that the vehicle is in a parked state, controlling, by the controller 20, the seat lifting device 30 to raise the at least a front seat 400 of the vehicle and simultaneously controlling, by the controller 20, the floor cleaning device 40 to be drawn out from the storage space and clean the floor of the vehicle.

An engine state is detected by the engine state sensor, a door lock state is detected by the door lock state sensor, and whether the vehicle is in a parked state is determined by the controller 20 based on engine state information output from the engine state sensor and the door lock state information output from the door lock state sensor.

The method further includes controlling, by the controller 20, the electric door 42 provided at an opening of the storage space 200 to be opened, before the controller 20 controls the floor cleaning device 40 to be drawn out from the storage space 200 and controlling, by the controller 20, the electric door 42 to be closed after the floor cleaning device returns to the storage space, and controlling the seat lifting device 30 to lower the front seat 400 of the vehicle to a position of the front seat 400 before the front seat 400 of the vehicle was raised.

The method further includes obtaining a user input by the input device 50 and controlling, by the controller 20, the electric door 42, the floor cleaning device 40, and the seat lifting device 30 based on a user input received from the input device 50.

A user input for turning on or off the cleaning function is obtained by the input device 50, the controller 20 is configured to control the electric door 42, the floor cleaning device 40, and the seat lifting device 30 to operate, when the controller 20 determines that the vehicle is in a parked state, based on the user input for turning on the cleaning function received by the controller 20 from the input device 50, and the controller 20 does not control the electric door 42, the floor cleaning device 40, and the seat lifting device 30, based on the user input for turning off the cleaning function received by the controller 20 from the input device 50.

In an exemplary embodiment of the present disclosure, the controller 20 is a vehicle head unit, and the input device 50 is a touch screen provided integrally with the display in the vehicle head unit. A user input for a cleaning start time is obtained by the input device 50, and the controller 20 is configured to control the electric door 42, the floor cleaning device 40, and the seat lifting device 30 to operate after the cleaning start time has elapsed since the vehicle was determined to be in a parked state, based on the user input of the cleaning start time received from the input device 50.

In another implementation method, the input device 50 is a touch screen provided integrally with the display of the remote control terminal 51, and a user input regarding a target in-vehicle temperature and a user input regarding a cleaning duration are obtained by the input device 50. The controller 20 is configured to control the electric door 42, the floor cleaning device 40, and the seat lifting device 30 based on the user input of the target in-vehicle temperature received from the input device 50 and is configured to control the air purifying device 60 to supply air to the vehicle interior so that an in-vehicle temperature reaches a target in-vehicle temperature. The controller 20 is configured to control the floor cleaning device 40 to clean the floor of the vehicle within the cleaning duration based on the user input of the cleaning duration received from the input device 50. Furthermore, communication between the remote control terminal 51 and the controller 20 is enabled by the remote control server 80. Communication between each of the controller 20, the air purifying device 60, and the seat lifting device 30 is enabled by the central gateway 70.

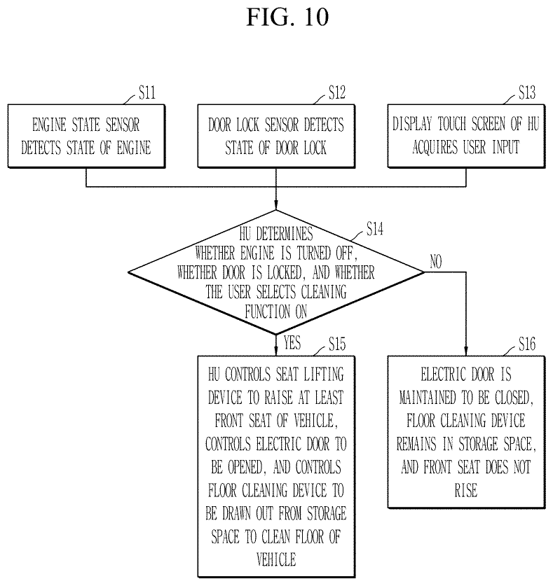

FIG. 10 is an operational flowchart of a cleaning method for a vehicle interior according to an exemplary embodiment of the present disclosure. As shown in FIG. 10, the engine state sensor is configured to detect an engine state (S11) and sends the engine state to the HU. The door lock state sensor is configured to detect a door lock state (S12) and sends the door lock state to the HU. A display touch screen of the HU receives a user input (S13).

The HU may be configured to determine whether the engine is turned off, whether the door lock is locked, and whether the user selects the cleaning function ON (S14). When the HU receives engine OFF state information, receives door lock-locked state information from the door lock state sensor, and receives a signal indicating that the user selects the cleaning function ON (“Yes” in S14), the HU is configured to control the seat lifting device 30 to raise the at least a front seat 400 of the vehicle, simultaneously is configured to simultaneously control the electric door 42 to be opened, and is configured to control the floor cleaning device 40 to be drawn out from the storage space 200 to clean the floor 100 (S15). However, among the three conditions that the HU receives engine OFF state information, that the HU receives door lock-locked state information from the door lock state sensor, and that the HU receives a signal indicating that the user selects the cleaning function ON, if any thereof is not met (“No” in S14), the HU does not control the seat lifting device 30, the electric door 42, and the floor cleaning device 40, so that the electric door 42 is maintained to be closed, the floor cleaning device 40 remains in the storage space 200, and the front seat 400 does not rise (S16).

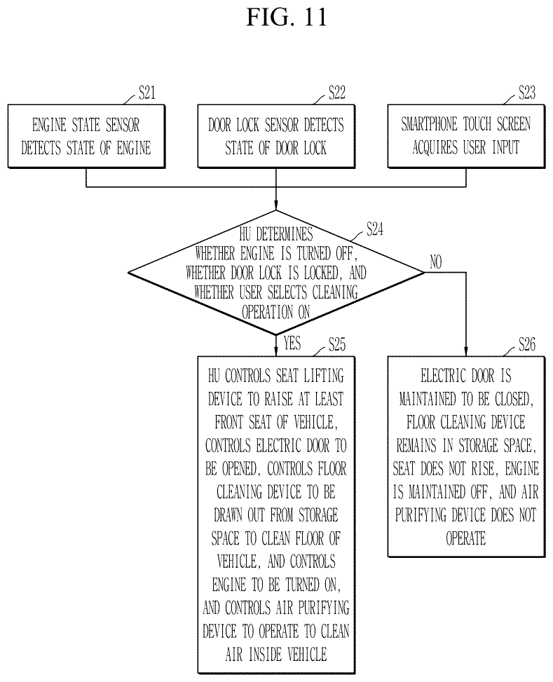

FIG. 11 is an operation flowchart of a cleaning method for a vehicle interior according to another exemplary embodiment of the present disclosure. As shown in FIG. 11, the engine state sensor is configured to detect an engine state (S21) and sends the engine state to the HU. The door lock state sensor is configured to detect a door lock state (S22) and sends the door lock state to the HU. The remote control terminal 51 (specifically, a smartphone) receives a user input (S23) and sends the user input to the HU. The HU may be configured to determine whether the engine is turned off, whether the door lock is locked, and whether the user selects a cleaning operation ON (S24). The ON of the cleaning operation may be determined through the selection of a cleaning duration. When the HU receives the engine OFF state information from the engine state sensor, receives the door lock-locked state information from the door lock sensor, and receives a signal indicating that the user selects the cleaning operation ON (“Yes” in S24), the HU is configured to control the seat lifting device 30 to raise the at least a front seat 400 of the vehicle, is configured to simultaneously control the electric door 42 to be opened, is configured to control the floor cleaning device 400 to be drawn out from the storage space 200 to clean the floor 100 of the vehicle, is configured to control the engine to be turned on, and is configured to control the air purifying device 60 to purify air inside the vehicle (S25). However, among the three conditions that the HU receives the engine OFF state information from the engine state sensor, that the HU receives the door lock-locked state information from the door lock sensor, and that the HU receives the signal indicating that the user selects the cleaning operation ON, if any one thereof is not met (“No” in S24), the HU does not control the seat lifting device 30, the electric door 42, the air purifying device 60, and the floor cleaning device 40, and thus, the electric door 42 is maintained to be closed, the floor cleaning device 40 remains in the storage space 200, and the front seat 400 does not rise (S26).

According to the implementation method of the present disclosure, when the user gets off a vehicle, a cleaning robot automatically cleans the floor of the vehicle, providing people with a clean environment in the vehicle and giving the user a good mood and health.

The cleaning system of the cleaning robot of the present disclosure is located on the lower side of the rear seat, is well hidden, does not occupy space in the vehicle, and includes a simple structure.

The cleaning system for a vehicle interior may be preset through a display of a vehicle head unit or a remote control terminal, and both the vehicle head unit and the remote control terminal provide a user interface (UI) control window. The user may select various operations from the UI control window. The smart control method provides users with excellent convenience and a smart experience.

Various implementation methods of the present disclosure as possible are not listed but the representative aspects of the present disclosure are described, and the contents described in various manners may be applied independently or in combination.

Furthermore, the term related to a control device such as “controller”, “control apparatus”, “control unit”, “control device”, “control module”, “control circuit”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured for processing data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

In the flowchart described with reference to the drawings, the flowchart may be performed by the controller or the processor. The order of operations in the flowchart may be changed, a plurality of operations may be merged, or any operation may be divided, and a predetermined operation may not be performed. Furthermore, the operations in the flowchart may be performed sequentially, but not necessarily performed sequentially. For example, the order of the operations may be changed, and at least two operations may be performed in parallel.

Hereinafter, the fact that pieces of hardware are coupled operably may include the fact that a direct and/or indirect connection between the pieces of hardware is established by wired and/or wirelessly.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A cleaning system for a vehicle interior, the cleaning system comprising:
a storage space provided on a lower side of a rear seat of a vehicle;
a floor cleaning device internally disposed within the storage space and configured to selectively move from the storage space to clean a floor of the vehicle;
at least one sensor configured to detect a driving state of the vehicle and to output corresponding state information of the vehicle;
a seat lifting device configured to raise and lower at least a front seat of the vehicle; and
a controller operably connected to the floor cleaning device, the at least one sensor and the seat lifting device and configured to determine whether the vehicle is in a parked state according to the state information output from the at least one sensor, to control, in response that the vehicle is in the parked state, the seat lifting device to raise the at least a front seat of the vehicle and simultaneously control the floor cleaning device to move out from the storage space to clean the floor of the vehicle.

2. The cleaning system of claim 1,
wherein the state information output from the at least one sensor includes an engine state information and a door lock state information,
wherein the at least one sensor includes an engine state sensor configured for detecting the engine state information and a door lock state sensor configured for detecting the door lock state information, and
wherein the controller is further configured to determine whether the vehicle is in the parked state based on the engine state information output from the engine state sensor and the door lock state information output from the door lock state sensor.

3. The cleaning system of claim 2,
wherein the storage space includes an opening and an electric door operably connected to the controller is coupled in the opening, and
wherein the controller is further configured to control the electric door to be open before the controller controls the floor cleaning device to move out from the storage space, to control the electric door to be closed after the floor cleaning device returns to the storage space, and to control the seat lifting device to lower the at least a front seat of the vehicle to a position of the at least a front seat before the at least a front seat was raised.

4. The cleaning system of claim 1, wherein the floor cleaning device is a cleaning robot, and at least one of a charging stand and a washing tank for the cleaning robot are provided in the storage space.

5. The cleaning system of claim 4, further including:
an input device operably connected to the controller and configured to obtain a user input,
wherein the controller is further configured to control the electric door, the floor cleaning device, and the seat lifting device based on the user input received from the input device.

6. The cleaning system of claim 5,
wherein the input device is further configured to obtain the user input to turn on or off a cleaning function of the cleaning system, and
wherein the controller is further configured to control the electric door, the floor cleaning device, and the seat lifting device to operate in response that the vehicle is in the parked state, based on the user input for turning on the cleaning function received from the input device, and
wherein the controller is further configured not to control the electric door, the floor cleaning device, and the seat lifting device based on the user input for turning off the cleaning function received from the input device.

7. The cleaning system of claim 6,
wherein the controller is a vehicle head unit, the input device is a touch screen provided integrally with a display in the vehicle head unit and is further configured to obtain a user input regarding a cleaning start time, and
wherein the controller is further configured to control the electric door, the floor cleaning device, and the seat lifting device to operate after the cleaning start time has elapsed since the vehicle was in the parked state, based on the user input of the cleaning start time received from the input device.

8. The cleaning system of claim 6, further including:
an air purifying device operably connected to the controller and configured to supply air from an outside of the vehicle to the vehicle interior to purify air inside the vehicle,
wherein the input device is a touch screen provided integrally with the display of the remote control terminal and is further configured to further obtain a user input regarding a target in-vehicle temperature and a user input regarding a cleaning duration, and
wherein the controller is configured to:
control the electric door, the floor cleaning device, and the seat lifting device based on the user input of the target in-vehicle temperature received from the input device, to control the air purifying device to supply air to the vehicle interior so that an in-vehicle temperature reaches the target in-vehicle temperature, and
control the floor cleaning device to clean the floor of the vehicle within the cleaning duration based on the user input of the cleaning duration received from the input device.

9. The cleaning system of claim 8, further including:
a remote control server operably connected to the controller and configured to enable communication between a remote control terminal and the controller; and
a central gateway operably connected to the controller and configured to enable communication between each of the controller, the air purifying device, and the seat lifting device.

10. A cleaning method for a vehicle interior, the cleaning method comprising:
detecting a driving state of a vehicle, by at least one sensor, and outputting corresponding state information of the vehicle;
determining, by a controller operably connected to the at least one sensor, whether the vehicle is in a parked state according to the state information output from the at least one sensor; and
in response that the controller concludes that the vehicle is in the parked state, controlling, by the controller, a seat lifting device operably connected to the controller to raise at least a front seat of the vehicle and simultaneously controlling, by the controller, a floor cleaning device operably connected to the controller, to move out from a storage space of the vehicle and clean a floor of the vehicle.

11. The cleaning method of claim 10,
wherein the state information output from the at least one sensor includes an engine state information and a door lock state information,
wherein the at least one sensor includes an engine state sensor and a door lock state sensor,
wherein engine state information is detected by the engine state sensor,
wherein door lock state information is detected by the door lock state sensor, and
wherein, whether the vehicle is in the parked state is determined by the controller based on the engine state information output from the engine state sensor and the door lock state information output from the door lock state sensor.

12. The cleaning method of claim 11, further including:
controlling, by the controller, an electric door operably connected to the controller and provided at an opening of the storage space to be opened, before the controller is further configured to control the floor cleaning device to move out from the storage space; and
controlling, by the controller, the electric door to be closed after the floor cleaning device returns to the storage space, and controlling, by the controller, the seat lifting device to lower the at least a front seat of the vehicle to a position of the at least a front seat before the at least a front seat of the vehicle was raised.

13. The cleaning method of claim 12, further including:
obtaining a user input by an input device operably connected to the controller; and
controlling, by the controller, the electric door, the floor cleaning device, and the seat lifting device based on the user input received from the input device.

14. The cleaning method of claim 12,
wherein a user input for turning on or off cleaning function is obtained by an input device operably connected to the controller,
wherein the controller is further configured to control the electric door, the floor cleaning device, and the seat lifting device to operate, in response that the controller concludes that the vehicle is in the parked state, based on the user input for turning on the cleaning function received by the controller from the input device, and
wherein the controller does not control the electric door, the floor cleaning device, and the seat lifting device, based on the user input for turning off the cleaning function received by the controller from the input device.

15. The cleaning method of claim 14,
wherein the controller is a vehicle head unit, the input device is a touch screen provided integrally with a display in the vehicle head unit,
wherein a user input for a cleaning start time is obtained by the input device, and
wherein the controller is further configured to control the electric door, the floor cleaning device, and the seat lifting device to operate after the cleaning start time has elapsed since the vehicle was in the parked state, based on the user input of the cleaning start time received from the input device.

16. The cleaning method of claim 14,
wherein the input device is a touch screen provided integrally with a display of a remote control terminal operably connected to the controller,
wherein a user input regarding a target in-vehicle temperature and a user input regarding a cleaning duration are obtained by the input device,
wherein the controller is further configured to control the electric door, the floor cleaning device, and the seat lifting device based on the user input of the target in-vehicle temperature received from the input device and is configured to control an air purifying device operably connected to the controller to supply air to the vehicle interior so that an in-vehicle temperature reaches the target in-vehicle temperature, and
wherein the controller is further configured to control the floor cleaning device to clean the floor of the vehicle within the cleaning duration based on the user input of the cleaning duration received from the input device.

17. The cleaning method of claim 16,
wherein communication between the remote control terminal and the controller is enabled by a remote control server operably connected to the controller, and
wherein communication between each of the controller, the air purifying device, and the seat lifting device is enabled by a central gateway operably connected to the controller.
